(19) United States
(12) Patent Application Publication
(10) Pub. No.: US 2021/0356946 A1
(43) Pub. Date: Nov. 18, 2021

(54) METHOD AND SYSTEM FOR ANALYZING AND/OR CONFIGURING AN INDUSTRIAL INSTALLATION

(71) Applicant: KUKA Deutschland GmbH, Augsburg (DE)

(72) Inventors: Jürgen Bock, Augsburg (DE); Manuel Kaspar, Augsburg (DE)

(21) Appl. No.: 17/257,434

(22) PCT Filed: Jul. 1, 2019
(86) PCT No.: PCT/EP2019/067510

§ 371 Date: Dec. 31, 2020

(30) Foreign Application Priority Data
Jul. 4, 2018 (DE) 10 2018 211 044.1

(51) Int. Cl. G05B 19/418; G06N 3/02

(52) U.S. Cl. CPC G05B 19/41865; G06N 3/02; G05B 19/41885; G05B 19/4183

(57) ABSTRACT

A method for analyzing and/or configuring an industrial installation, which has at least one first installation component for capturing, handling and/or machining at least one first object. A process success of the first installation component is predicted and/or a value for a configuration parameter of the first installation component is determined on the basis of at least one first object model of the first object with the aid of at least one first machine-learned component model of the first installation component.

### CROSS-REFERENCE TO RELATED APPLICATIONS

This application is a national phase application under 35 U.S.C. § 371 of International Patent Application No. PCT/EP2019/067510, filed Jul. 1, 2019 (pending), which claims the benefit of priority to German Patent Application No. DE 10 2018 211 044.1, filed Jul. 4, 2018, the disclosures of which are incorporated by reference herein in their entirety.

### TECHNICAL FIELD

The present invention relates to a method for analyzing and/or configuring an industrial installation, and to a system and computer program product for carrying out the method.

### BACKGROUND

Industrial installations have several installation components, for example sensors, actuators, conveyors, robot (cells) and the like, with which objects are (to be) captured, transported and/or machined.

The object of the present invention is to improve such industrial installations or their design.

This object is solved by a method and a system or computer program product for carrying out the method, as described herein.

According to one embodiment of the present invention, for analyzing and/or configuring an industrial installation which has at least one first installation component, by means of which at least one first object is or is to be captured, in particular sensorially, in one embodiment optically, and/or handled, in particular mechanically, in one embodiment picked up, in particular grasped, transported and/or delivered, in particular deposited or placed, and/or processed, in particular machined, in one embodiment formed and/or shaped, or which is provided, in particular adapted or used for this purpose, predicts, on the basis of at least one first object model of the first object with the aid of at least one first machine-learned component model of the first installation component, a process success of the first installation component (in the capture, handling or machining of the first object) and/or determines a value for a one- or multi-dimensional configuration parameter of the first installation component, in particular for the capture, handling or machining of the first object.

The designation “first” is used here without restricting the generality.

An object model of an object is understood here to be an, in particular digital, characterization of the object. In one embodiment it has digital, stored, predetermined, theoretical, captured and/or current data of the object, in one embodiment it has image data, dimensions and/or mechanical, in particular kinetic and/or kinematic, thermal, electrical and/or optical parameters, in particular a weight, a mass distribution, material properties, temperatures, surface properties, currents, forces or the like, in one embodiment it consists of these.

Thus, an example of an object model of an object is in particular one or more images of the object.

In one embodiment, a machine-learned component model of an installation component forms (maps), in particular classifies, an object model of an object, in particular numerically and/or digitally, on or into a one- or multi-dimensional output vector, which depends on a process success, in particular a feasibility, a capture, handling or machining of the object by means of the installation component and/or on a one- or multi-dimensional configuration parameter of the installation component, indicates it in one embodiment, or is adapted or used for this purpose. In one embodiment, it has an, in one embodiment deep, neural network; it may in particular consist of it. Additionally or alternatively, the machine-learned component model of an installation component parameterizes or configures the installation component on the basis of, or with the value(s) for the configuration parameter, or is adapted or used for this purpose.

By using a machine-learned model of at least one installation component of an industrial installation, the latter can be designed advantageously, in particular quickly, simply, precisely and/or reliably, in one embodiment, in particular a feasibility analysis of process steps can be carried out in advance and/or configuration parameters of installation components can be determined and the installation components can be parameterized or configured accordingly on the basis of these determined configuration parameters.

In one embodiment, on the basis of the first object model of the first object and/or at least one object model of at least one further object, with the aid of at least one machine-learned component model of at least one further installation component, a process success of this installation component (in the capture, handling or machining of this object) is predicted and/or a value for a configuration parameter of this installation component, in particular for the capture, handling or machining of this object, is determined, in one embodiment, the installation components are parameterized or configured on the basis of this determined configuration parameter.

Thus, in one embodiment, machine-learned component models are used for different installation components, respectively, to predict their process success or to parameterize or configure them.

Due to this modularity, the individual component models can be advantageously trained and/or used separately in one embodiment and thereby in particular a modification of the industrial installation can be advantageously, in particular quickly and/or simply, taken into account or a modified industrial installation can be advantageously, in particular quickly, simply, precisely and/or reliably, (re)designed. Additionally or alternatively, component models can thereby be optimized and/or used for the design of different industrial installations.

Additionally or alternatively, in one embodiment, on the basis of at least one object model of at least one further object, a process success of the first installation component (in the capture, handling or machining of this further object) is predicted with the aid of the first component model of the first installation component, and/or a value for a configuration parameter of the first installation component, in particular for the capture, handling or machining of this further object, is determined, in one embodiment, the first installation component is parameterized or configured on the basis of this determined configuration parameter.

Hereby, in one embodiment, the feasibility of more complex processes can be improved or even made possible in the first place.

In one embodiment, at least one component model of (at least) one installation component, in particular therefore the first component model of the first installation component and/or the machine-learned component model of the at least one further installation component (in each case), is trained on the basis of one or more different, in particular object models of the first object that are of the same type.

In this way, in one embodiment, the informative value of this component model for the first object can be improved.

In addition or alternatively, in one embodiment at least one component model of (at least) one installation component, in particular therefore the first component model of the first installation component and/or the machine-learned component model of the at least one further installation component (in each case), is trained on the basis of one or more different, in particular object models of the same type of one or more further objects, which are of the same type as the first object.

In addition or alternatively, in one embodiment at least one component model of (at least) one installation component, in particular therefore the first component model of the first installation component and/or the machine-learned component model of the at least one further installation component (in each case), is trained on the basis of one or more different, in particular object models of the same type of one or more further objects which are of a different type than the first object.

In one embodiment, this can improve the robustness of this component model.

Thus, in one embodiment, at least one component model of (at least) one installation component, in particular therefore the first component model of the first installation component and/or the machine-learned component model of the at least one further installation component (in each case), is trained on the basis of several different, object models of the same type of one or more objects, it being possible for these objects in turn to have in one embodiment objects of the same type and/or of a different type or of an unequal type, in particular negative examples of the first object.

For example, a component model can be trained on the basis of different images (object models of the same type) of a plurality of screws (objects of the same type) and nuts (objects of a different type or of an unequal type).

Additionally or alternatively, in one embodiment at least one component model of (at least) one installation component, in particular thus the first component model of the first installation component and/or the machine-learned component model of the at least one further installation component (in each case), is trained partially or completely before installation of this installation component.

In particular, a manufacturer or supplier of the installation component can thus at least pre-train or also fully train a component model for the installation component in advance and then provide this pre-trained or fully trained component model, in particular for the design of the industrial installation, in particular for the design of various industrial installations, in particular in the form of a so-called management shell in the sense of an “Industry 4.0 component.” Hereby, in one embodiment, this can reduce a design effort.

Additionally or alternatively, in one embodiment, a manufacturer or supplier of the first and/or at least one further object can also provide the object model of this object, in particular in the form of a so-called management shell in the sense of an “Industry 4.0 component.”

In one embodiment, training of a machine-learned component model on the basis of an object model comprises an, in particular supervised, deep and/or reinforcing machine learning (“(supervised/deep) machine learning; reinforcement learning”), in particular an input of the object model, an evaluation of an output or of the output vector of the component model, and an adaptation or modification of the component model on the basis of this evaluation.

In one embodiment, the first component model of the first installation component and the first object model of the first object are provided to a host (computer) that predicts (on its basis) the process success and determines the value for the configuration parameter, respectively.

In a further embodiment, the host predicts a process success of at least one further installation component on the basis of the first object model and/or (of the) at least one object model of at least one further object with the aid of (the) at least one machine-learned component model of at least one further installation component and/or determines a value for a configuration parameter of this installation component on the basis of the first object model and/or (of the) at least one object model of at least one further object with the aid of (the) at least one machine-learned component model of at least one further installation component. Additionally or alternatively, in one embodiment, the host predicts a process success of this installation component based on (the) at least one object model of at least one further object with the aid of the first component model of the first installation component and/or determines a value for a configuration parameter of this installation component based on (the) at least one object model of at least one further object with the aid of the first component model of the first installation component. In particular, the host can thus load the (respective) component model and use it as input vectors for processing the object model(s).

In one embodiment, the host may be separate or distinct from the (respective) installation component and/or have one or more CPUs, GPUs, and/or neural computing chips and/or framework, for example, TensorFlow, Torch, Gaffe, or the like. The component model(s) can preferably be made available or provided in ONNX (“Open Neural Network Exchange”) format or similar, preferably standardized formats.

In one embodiment, this can improve, in particular accelerate, the evaluation of the respective component model.

In one embodiment, at least one object model of (at least) one object, in particular thus the first object model of the first object and/or the at least one further object model of the at least one further object (in each case), is made available to the (corresponding) component model with the aid of the first and/or at least one further installation component.

If, for example, an object model has an image of an object, then in one embodiment the installation component whose component model uses this object model or also another installation component can pick up this image and make it available to the component model.

In this way, in one embodiment, particularly informative object models can be used and thereby the prediction of the process success or the configuration or parameterization of the installation component can be improved.

Similarly, in one embodiment, at least one object model of (at least) one object, in particular thus the first object model of the first object and/or the at least one further object model of the at least one further object (in each case) can be provided to the (corresponding) component model without the use, or with the use of the first and/or at least one further installation component, in particular, as explained above, by the supplier of the object.

In turn, if for example an object model has an image of an object, in one embodiment this image can thus be taken in advance, for example by the manufacturer of the object, and made available to the component model.

In one embodiment, this can reduce a design effort.

In one embodiment, at least one installation component, in particular therefore the first installation component and/or the at least one further installation component (in each case), has at least one, in particular optical, sensor, in one embodiment a camera, and/or at least one, in particular electromotive, actuator, in one embodiment at least one, in particular multi-axis, preferably at least six-axis, in particular at least seven-axis, robot, at least one machine tool and/or at least one conveyor.

Due to its flexibility and/or complexity, the present invention can be used with particular advantage in industrial installations with such installation components or for their design, in particular for feasibility analyses of processes of such installation components and/or for configuration or parameterization of such installation components.

According to one embodiment of the present invention, a system is adapted, in particular in terms of hardware and/or software, in particular in terms of programming, for carrying out a method described herein and/or has means for predicting a process success of the first installation component and/or determining a value for a configuration parameter of the first installation component on the basis of at least one first object model of the first object with the aid of at least a first machine-learned component model of the first installation component.

In one embodiment, the system or its means comprises:

Means for predicting a process success of at least one further installation component and/or determining a value for a configuration parameter of at least one further installation component on the basis of the first object model and/or at least one object model of at least one further object with the aid of at least one machine-learned component model of this installation component; and/or
means for predicting a process success of the first installation component and/or determining a value for a configuration parameter of the first installation component on the basis of at least one object model of at least one further object with the aid of the first component model of the first installation component; and/or
means for training at least one component model of an installation component on the basis of one or more different, in particular object models of the same type of the first object, at least one further object of the same type and/or at least one object of the same type as the first object; and/or
means for training at least one component model of an installation component at least partially before installation of this installation component; and/or
a host for predicting a process success of the first installation component and/or determining a value for a configuration parameter of the first installation component on the basis of at least one first object model of the first object made available to the host with the aid of at least one first machine-learned component model of the first installation component made available to the host, in particular for predicting a process success of at least one further installation component and/or determining a value for a configuration parameter of at least one further installation component on the basis of the first object model made available to the host and/or at least one object model made available to the host of at least one further object with the aid of at least one machine-learned component model of this installation component made available to the host; and/or
means for predicting a process success of the first installation component and/or determining a value for a configuration parameter of the first installation component on the basis of at least one object model of at least one further object made available to the host with the aid of the first component model of the first installation component made available to the host; and/or
means adapted to provide or not provide at least one object model of an object to the component model using the first and/or at least one further installation component.

A means in the sense of the present invention can be designed in terms of hardware and/or software, in particular having a processing unit, in particular a microprocessor unit (CPU), graphics card (GPU) or the like, preferably connected to a memory and/or bus system in terms of data or signals, and/or having one or more programs or program modules. The processing unit may be adapted to process commands implemented as a program stored in a memory system, to capture input signals from a data bus, and/or to output signals to a data bus. A memory system may have one or more, in particular different, storage media, in particular optical, magnetic, solid state and/or other non-volatile media. The program may be such that it embodies or is capable of executing the methods described herein, such that the processing unit is capable of executing the steps of such methods. In one embodiment, a computer program product may comprise, in particular be, a storage medium, in particular a non-volatile storage medium, for storing a program or having a program stored thereon, wherein execution of said program causes a system or controller, in particular a computer, to execute a method described herein or one or more of its steps.

In one embodiment, one or more, in particular all, steps of the method are carried out completely or partially automated, in particular by the system or its means. In one embodiment, the system comprises the first and/or at least one further installation component, in particular the industrial installation.

In the present context, “of the same type” is understood to mean in particular that two elements have the same type or belong to a common class or are (can be) assigned to a common class. For example, a first image and a second image can be object models of the same type, while an image and CAD data can be object models of different types. Similarly, two different screws, for example, can be objects of the same type, while a screw and a nut can be objects of different types. As already mentioned above, in one embodiment, object models of objects of different types are advantageously used for training a component model, some of these objects being positive examples for which, in particular, a positive process success is predicted or a certain value of the configuration parameter is, or is to be determined for the first object, and other objects being negative examples for which, in particular, a negative process success is predicted or a different value of the configuration parameter is, or is to be determined.

When predicting a process success or determining a value for a configuration parameter on the basis of an object model with the aid of a machine-learned component model, further (process) data can be taken into account in one embodiment.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 illustrates a method and system for analyzing and/or configuring an industrial installation according to one embodiment of the present invention.

### DETAILED DESCRIPTION

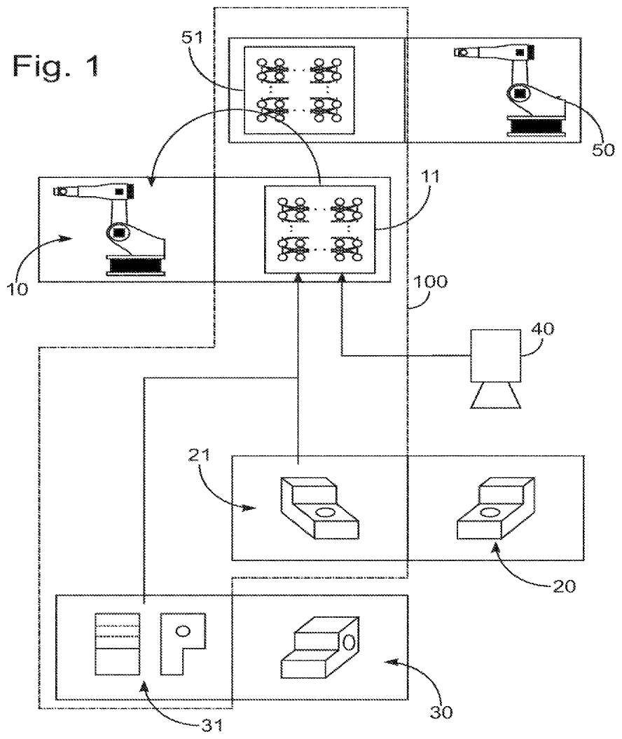

FIG. 1 shows a method and system for analyzing and/or configuring an industrial installation according to one embodiment of the present invention.

Exemplarily, the installation comprises a first installation component in the form of a robot 10, which is to machine a first object 20 and objects of the same type with respect thereto, and a further object 30 of a different type and objects of the same type with respect thereto, a further installation component in the form of a camera 40, and another further installation component in the form of a further robot 50.

A first machine-learned component model of the robot 10 in the form of a deep neural network 11 as well as a machine-learned component model of the further robot 50 in the form of a further deep neural network 51 are provided by the robot manufacturer and loaded onto a host 100, which have been pretrained or fully trained at the manufacturer.

From the supplier of the further object 30, an object model 31 of that object is provided and loaded onto the host 100.

An image 21 of the first object 20 is taken by the camera 40 and provided to the host 100 as an object model 21 of that object.

On the basis of these object models 21, 31, the host 100 analyzes, with the aid of the component model 11, whether a planned machining of the objects 20, 30 by means of the robot 10 is (probably) feasible and, if necessary, parameterizes the robot 10 for this purpose or outputs corresponding configuration parameter values.

Analogously, the host 100 uses the component model 51 to analyze, on the basis of the object models 21, 31, whether planned machining of the objects 20, 30 by means of the robot 50 is (probably) feasible, and, if necessary, parameterizes the robot 50 or outputs corresponding configuration parameter values.

The robot manufacturer has trained the neural networks 11, 51 on the basis of camera images, as provided by cameras of the type of camera 40, and CAD data 31, as provided for the further object 30, for example, in order to classify whether the robot 10 or 50 can grasp the corresponding object, or to determine suitable grasping poses. For this purpose, in addition to object models, in the embodiment camera images or CAD data of objects which are of the same type as the objects 20, 30 to be handled by robot 10 or 50, object models of objects which are of a different type than such objects are also used, in particular of objects which are not to be handled by robot 10 or 50 or which are to be handled with different configuration parameter values, in order to also provide the neural networks 11, 51 with negative examples.

In one embodiment, the (pre-trained) neural network 11 or 51 may be fully trained based on camera images from the camera 40.

Although embodiments have been explained in the preceding description, it should be noted that a plurality of variations are possible.

For example, in the above embodiment, object models of a different type are machined in the component models 11, 51, namely images 21 on the one hand and CAD data 31 on the other hand.

In one variation, instead, only object models of the same type are processed in one or both of the component models 11, 51 in each case, i.e. in the embodiment only images 21 or only CAD data 31 are processed in each case in the component models 11 and/or 51.

This allows the neural networks 11, 51 to operate advantageously, in particular more specifically, and thus in one embodiment to improve their speed, robustness and/or precision.

Additionally or alternatively, the neural network 11 and/or 51 (respectively) can also be trained first on the basis of the images captured by the camera 40.

Thus, for example, the robot manufacturer may (pre-)train the neural network 11 based on camera images, such as those provided by cameras of the type of camera 40, of objects of the type of the object 20 as positive examples and of objects of the type of the object 30 as negative examples.

If, in operation, the camera 40 then captures a first object of the type of the object 20, the neural network 11 can predict a positive process success for this or set or predetermine or output corresponding configuration parameter values for this, for example grasping positions or the like.

If, on the other hand, the camera 40 captures a first object of the type of the object 30 during operation, the neural network 11 can predict a negative process success for this or set or predetermine or output corresponding other configuration parameter values for this, for example other grasping positions or the like.

Furthermore, it should be noted that the embodiments are merely examples which are not intended to limit the scope of protection, the applications and the design in any way. Rather, the preceding description provides the person skilled in the art with a guideline for the implementation of at least one embodiment, whereby various modifications, in particular with respect to the function and arrangement of the described components, can be made without leaving the scope of protection as it results from the claims and these equivalent combinations of features.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### REFERENCE SIGN LIST

10 Robot (first installation component)
11 Deep neural network (first machine-learned component model)
20 First object
21 Image (first object model) of the first object
30 Further object
31 CAD data (object model) of the further object
40 Camera (further installation component)
50 Robot (further installation component)
51 Deep neural network (machine-learned component model)
100 Host

What is claimed is:

1-9. (canceled)

10. A method for analyzing and/or configuring an industrial installation, which includes at least one first installation component for capturing, handling, and/or machining at least one first object, the method comprising:
at least one of:
predicting a process success of the first installation component, or
determining a value for a configuration parameter of the first installation component;
wherein the predicting or determining is based on at least one first object model of the first object with the aid of at least one first machine-learned component model of the first installation component.

11. The method of claim 10, further comprising:
at least one of:
predicting a process success of at least one second installation component, or
determining a value for a configuration parameter of the at least one second installation component;
wherein the predicting or determining is based on at least one of:
at least one of the first object model or at least one second object model of a second object, with the aid of at least one second machine-learned component model of the at least one second installation component, or
the at least one second object model of the second object, with the aid of the first machine-learned component model of the first installation component.

12. The method of claim 10, wherein at least one component model of an installation component is at least one of:
trained based on one or more object models of at least one of:
a) the first object,
b) at least one second object of the same type as the first object, or
c) at least one second object of a different type than the first object;
trained at least partially before installation of the installation component; or
has a neural network.

13. The method of claim 12, wherein:
the at least one component model of an installation component is trained based on more than one different object models; and
the different object models are of the same type.

14. The method of claim 12, wherein the neural network is a deep neural network.

15. The method of claim 10, further comprising:
making the first component model of the first installation component and the first object model of the first object available to a host;
wherein the host predicts the process success and determines the value for the configuration parameter, respectively.

16. The method of claim 15, further comprising:
at least one of:
predicting with the host a process success of at least one second installation component, or
determining with the host a value for a configuration parameter of the at least one second installation component;
wherein the predicting or determining is based on at least one of:
at least one of the first object model or at least one second object model of a second object, with the aid of at least one second machine-learned component model of the at least one second installation component, or
the at least one second object model of the second object, with the aid of the first machine-learned component model of the first installation component.

17. The method of claim 10, wherein at least one of:
the method further comprises making at least one object model of an object available to the component model with the aid of at least one of the first installation component or at least one second installation component; or
at least one object model comprises at least one of:
image data of the object,
dimensions of the object, or
at least one of mechanical, thermal, electrical, or optical parameters of the object.

18. The method of claim 10, wherein at least one installation component comprises at least one of:
at least one sensor;
at least one actuator;
at least one machine tool; or
at least one conveyor.

19. The method of claim 10, wherein at least one of:
the at least one sensor is an optical sensor;
the at least one actuator is an electromotive actuator; or
the at least one actuator is a robot.

20. A system for analyzing and/or configuring an industrial installation, which includes at least one first installation component for capturing, handling, and/or machining at least one first object, the system comprising:
means for at least one of:
predicting a process success of the first installation component, or
determining a value for a configuration parameter of the first installation component;
wherein the predicting or determining is based on at least one first object model of the first object with the aid of at least one first machine-learned component model of the first installation component.

21. A computer program product for analyzing and/or configuring an industrial installation, which includes at least one first installation component for capturing, handling, and/or machining at least one first object, the computer program product comprising program code stored on a non-transient, computer-readable storage medium, the program code, when executed on a computer, causing the computer to:
at least one of:
predict a process success of the first installation component, or
determine a value for a configuration parameter of the first installation component;
wherein the predicting or determining is based on at least one first object model of the first object with the aid of at least one first machine-learned component model of the first installation component.
